(19) United States
(12) Patent Application Publication
(10) Pub. No.: US 2011/0203829 A1
(43) Pub. Date: Aug. 25, 2011

(54) SUPERCONDUCTING CABLE WITH WIDE-WIDTH TYPE SUPERCONDUCTING STRIP LINES

(75) Inventors: Hyun Man Jang, Gyeonggi-do (KR); Su Kil Lee, Gyeongsangbuk-do (KR); Choon Dong Kim, Gyeonggi-do (KR); Chang Youl Choi, Gyeongsangbuk-do (KR)

(73) Assignee: LS CABLE LTD., Anyang-si, Gyeonggi-do (KR)

(21) Appl. No.: 13/126,825

(22) PCT Filed: May 28, 2009
(86) PCT No.: PCT/KR2009/002837

§ 371 Date: Apr. 29, 2011

(30) Foreign Application Priority Data
Oct. 31, 2008 (KR) 10-2008-0107916

(51) Int. Cl. H01B 11/18

(52) U.S. Cl. 174/102 R

(57) ABSTRACT

A superconducting cable having wide-width superconducting strip lines. The superconducting cable having wide-width superconducting strip lines includes, from the center of the cable, a former, a superconducting layer, an electronic insulation layer, and a superconducting shield layer. The superconducting layer is formed as a plurality of superconducting strip lines spirally wound around the circumference of the former, and each of the strip lines has a rectangular cross section. The strip lines are, respectively, made up of a wide-width strip line of which the ratio of the width to the thickness is within the range of 20 to 30. The cable may prevent to deteriorate the efficiency of the cable, by reducing the vertical element of the magnetic field occurred around the strip lines. The structure disclosed herein may reduce the whole intensity of the magnetic field, and reduce the whole outer diameter of the cable.

### TECHNICAL FIELD

This disclosure relates to a superconducting cable having wide-width superconducting strip lines, and specifically to a superconducting cable which includes wide-width superconducting strip lines having the aspect ratio of a wide-width type, and being uniformly arranged around and closely attached to the circumference of a former.

### BACKGROUND ART

Using superconducting strip lines as a conductor, a superconducting cable can transmit a higher capacity of electric power than typical power cables.

FIG. 1 generally illustrates the structure of a typical superconducting cable.

As illustrated FIG. 1, the superconducting cable has at least one, for example, three conducting cores 10 arranged inside of an outer cryostat 20. The space 30 between the cores 10 and the cryostat 20 is filled with a refrigerant to maintain the cores 10 at an extremely low temperature.

The cryostat 20 generally includes an inner metallic tube 21, an insulating layer 22 surrounding the inner tube 21, and an outer metallic tube 23. The space between the insulating layer 22 and the outer tube 23 is formed as a vacuum layer 24.

FIG. 2 generally depicts the structure of the core 10 of the superconducting cable of FIG. 1.

As described in FIG. 2, the core 10 has, from its center, formers 11, a superconducting layer 12, an electronic insulation layer 13, a superconducting shield layer 14, and a protection layer 15.

The formers 11 are formed as metal wires (e.g. copper wires) twisted together or as hollow metal pipes which are used as paths of a refrigerant.

The superconducting layer 12 and the superconducting shield layer 14 are formed with a plurality of superconducting thin strip lines 50 arranged around the outer surfaces of the formers 11 and the electronic insulation layer 13, respectively.

FIG. 3 is a sectional view diagrammatically illustrating the arrangement and the structure of the superconducting strip lines 50 stated above. FIG. 3 represents, for clarity, only the structure of the superconducting strip lines constituting the superconducting layer 12, but this explanation may apply to the structure of the superconducting strip lines constituting the superconducting shield layer 14 because both have identical structures. So, the explanation on the superconducting shield layer 14 will be omitted.

As depicted in FIG. 3, the cross-section of the superconducting strip line 50 is formed as a rectangular shape with a small thickness and a large width. A number of the lines 50 are wound spirally around the outer surface of the formers 11 at an adequate pitch.

Such superconducting strip lines 50 have the thickness not more than 0.5 mm, typically about 0.4 mm, and the width of about 4 mm, resulting in an aspect ratio (width/thickness) of about 10. In the case that these superconducting strip lines 50 are wound around the circumference of the formers 11, the lines 50 may remain in its original rectangular shape because the lines 50 may not undergo plastic deformation due to the high mechanical strength at both ends of the lines 50. In this structure, the lines 50 may not adhere to the outer surface of the formers 11, but curl up at its ends. This leads to the increased thickness of the superconducting layer 12, and thus to the increased diameter of the whole superconducting cable. As a result, the intensity of the magnetic field in the vertical direction with respect to the strip lines 50 increases between the neighboring strip lines 50, and thus the efficiency of the superconducting strip lines is deteriorated. That is, the critical current is decreased, causing the capacity of power transmission to be reduced, and increasing the AC loss.

When the superconducting strip lines are exposed to magnetic fields, the critical current decreases as the intensity of the surrounding magnetic field increases. In other words, the capacity of the critical current is in inverse proportion to the intensity of the surrounding magnetic field. When the magnetic field is formed in a direction perpendicular to the surface of the superconducting strip line, the critical current decreases greatly.

When current flows through the superconducting strip line of the superconducting cable, the magnetic field is generated by the current flow, and is offset and/or crossed over by another magnetic field generated at the adjacent superconducting strip line. As a result, the whole superconducting strip lines fall under the influence of the magnetic field.

However, the existing superconducting strip lines have a small aspect ratio, i.e. the relative size of width to thickness is small, and thus have high mechanical strength at the edges of the lines. So, the lines may not completely adhere to the circumference of the formers, but are wound with their original shapes substantially remained. This leads to the increase in the strength of the magnetic field in the vertical direction, and thus deteriorates the efficiency of the superconducting strip lines and causes the significant loss of AC current.

### DISCLOSURE

### Technical Problem

The inventors of the cable explained hereafter found that, in order to prevent the efficiency of superconducting strip lines from being deteriorated due to the magnetic field, the element of the magnetic field in the vertical direction may be reduced by uniformly arranging the strip lines around the circumference of a former, and by reducing the gap between neighboring strip lines.

As a result, if the aspect ratio of the superconducting strip lines can be increased without resulting in difficulty in winding the strip lines, the strip lines may adhere to the circumference of the former with larger surface, as wound around the former. This leads to the reduction of the vertical element of the magnetic field so as to improve the efficiency of the strip lines and to reduce the AC loss.

Therefore, there is provided a superconducting cable having wide-width superconducting strip lines to reduce the element of the magnetic field in the vertical direction so as to prevent the efficiency of the cable from being deteriorated, and also to reduce the outer diameter of the cable. This may be achieved by the structure that, by adjusting the aspect ratio of the superconducting strip lines using wide-width type strip lines, the strip lines are adopted to the shape of the circumference of the former so that the strip lines closely adhere to and are uniformly arranged around the former, and so that the gap between neighboring strip lines is reduced.

### TECHNICAL SOLUTION

A superconducting cable having wide-width superconducting strip lines according to the embodiment herein comprises, from the center of the cable, a former, a superconducting layer, an electronic insulation layer, and a superconducting shield layer. The superconducting layer is formed as a plurality of superconducting strip lines spirally wound around the circumference of the former, and each of the strip lines has a rectangular cross section. Further, the strip lines are, respectively, made up of a wide-width strip line of which the ratio of the width to the thickness is within the range of 20 to 30.

In the superconducting cable according to the embodiment, the superconducting shield layer may be formed with wide-width superconducting strip lines in the same way as that of the superconducting layer.

Each of the superconducting strip lines may be a piece of strip line having the thickness of 0.5 mm or less.

Each of the superconducting strip lines may also be formed as two strip lines integrally arranged on a substrate side by side in the direction of the width, and each of the two strip lines may have the thickness of 0.5 mm or less. In this case, the whole width of the two strip lines integrally arranged may be 20 to 30 times larger than the thickness of the two strip lines.

### ADVANTAGEOUS EFFECTS

According to the embodiment herein, because the superconducting layer is formed with wide-width superconducting strip lines having the aspect ratio of 20 to 30, the strip lines may adhere closely to the former and be wound around the circumference of the former.

Further, the gap between neighboring strip lines may be reduced.

Moreover, the cable according to the embodiment may prevent the efficiency of the cable from being deteriorated, by reducing the vertical element of the magnetic field occurring around the strip lines. And the structure disclosed herein may reduce the whole intensity of the magnetic field, and reduce the whole outer diameter of the cable.

### DESCRIPTION OF DRAWINGS

The above and other aspects, features and advantages of the disclosed exemplary embodiments will be more apparent from the following detailed description taken in conjunction with the accompanying drawings in which:

FIG. 1 generally illustrates the structure of a typical superconducting cable;

FIG. 2 generally depicts the structure of the core of the superconducting cable of FIG. 1;

FIG. 3 is a sectional view diagrammatically illustrating the arrangement and the structure of the superconducting strip lines of FIG. 2;

FIG. 4 is a sectional view diagrammatically illustrating the arrangement and the structure of the superconducting strip line according to the embodiment; and

FIG. 5 is a diagrammatic view illustrating the cross-section and the arrangement of the superconducting strip line according to another embodiment.

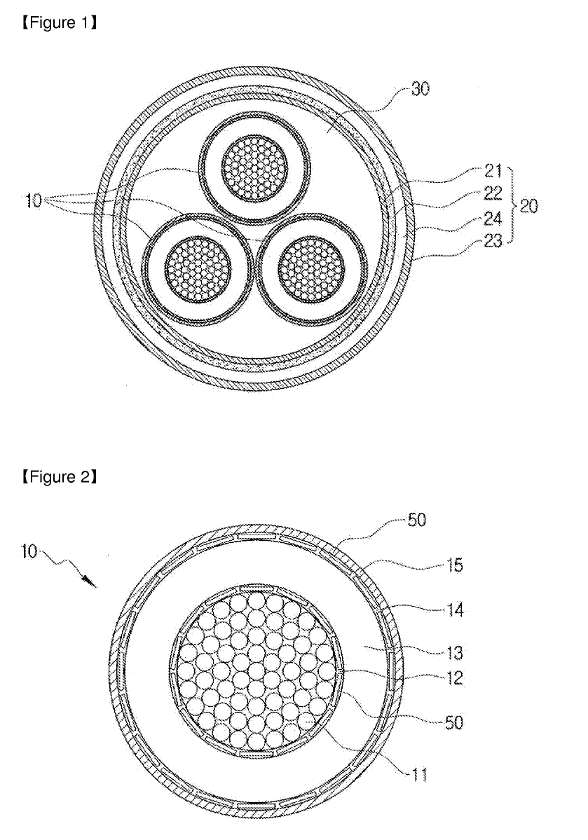

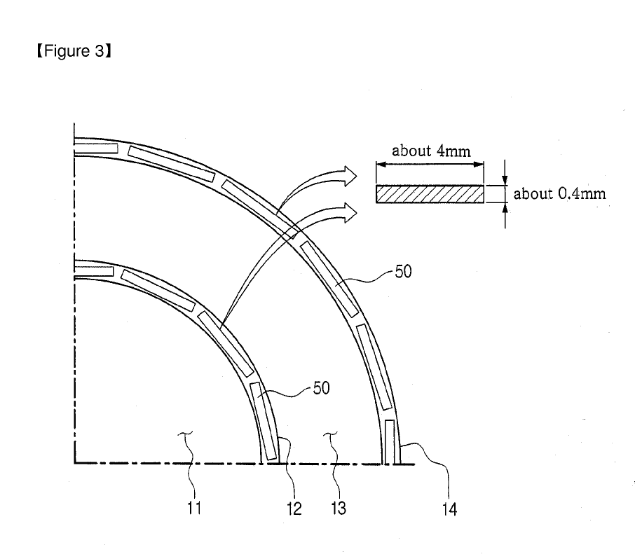

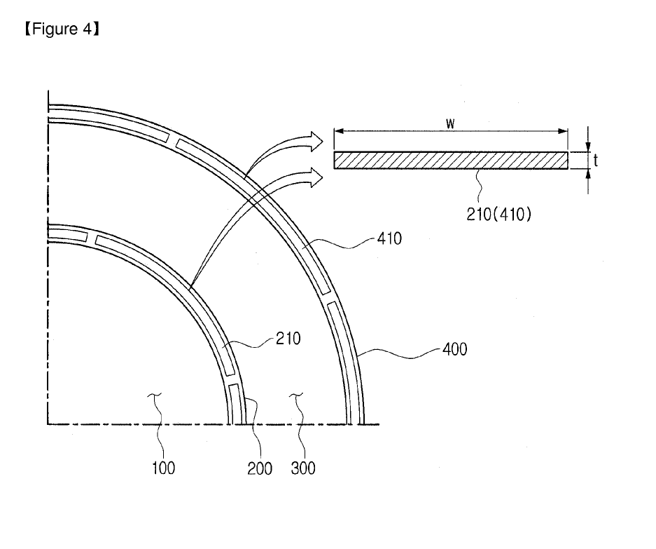

### BEST MODE

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise.

Furthermore, the use of the terms a, an, etc. does not denote a limitation of quantity, but rather denotes the presence of at least one of the referenced item. The use of the terms “first”, “second” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

FIG. 4 is a sectional view diagrammatically illustrating the arrangement and the structure of the superconducting strip line according to the embodiment herein.

As depicted in FIG. 4, the superconducting cable according to the embodiment has a former 100 at its core and a superconducting layer 200 in which a plurality of wide-width superconducting strip lines 210 are arranged on the outer surface of the former 100. The lines 210 have a length, and are shaped with a rectangular cross-section. FIG. 4 does not describe the length of the lines 210, but represents the width (w) and the thickness (t) in the cross sectional view of the lines. An insulation layer 300 is formed on the outer surface of the superconducting layer 200, and a superconducting shield layer 400 is arranged on the circumference of the insulation layer 300.

The former 100 is formed as twisted metallic wires, or consists of metallic pipes. The wide-width superconducting strip lines 210 are arranged on the circumference of the former 100. For example, the strip lines 210 are spirally wound along the longitudinal direction, and constitute the superconducting layer 200, which transmits power in the superconducting cable.

The superconducting shield layer 400 is formed by winding the superconducting strip lines around the circumference of the electronic insulation layer 300. When current flows through the superconducting layer 200, another current, the amount of which is substantially the same as that of the current flow of the layer 200, is induced in the shield layer 400 in the opposite direction to that of the current flow of the layer 200, so the magnetic field of the layer 200 is so cancelled as to prevent leakage of the magnetic field. As illustrated in FIG. 4, similarly to the wide-width superconducting strip lines 210 arranged around the circumference of the former 100, the wide-width superconducting strip lines 410 may be spirally wound along the longitudinal direction, and constitute the shield layer 400.

In the embodiment, the width of the wide-width strip lines 210 and 410 is twice as wide as that of existing strip lines. The ratio of the width (w) to the thickness (t), i.e. the aspect ratio (w/t), of the strip lines 210 and 410 may be about 20 to 30. If the aspect ratio is within the range of 20 to 30, the process for winding the strip lines 210 and 410 may be done without significant difficulty while achieving the purpose of this disclosure.

The strip lines 210 and 410 may have a thickness not more than 0.5 mm. For example, if the thickness of the lines 210 and 410 is 0.4 mm, the width of the lines may be about 8 to 12 mm, in order for the aspect ratio to be within the range of 20 to 30 as stated above.

If the thickness of the lines 210 and 410 is exactly 0.4 mm and the aspect ratio is exactly 20, the width of the lines is exactly 8 mm. This aspect ratio is about twice, with respect to the width of the existing lines.

When the superconducting strip lines are formed as the wide-width strip lines 210 and 410 with the aspect ratio of not less than 20 as described herein, the strip lines may be very closely attached to and wound around substantially entire surface of the circumference of the former 100 or the insulation layer 300, and the gap between the neighboring strip lines may be reduced more than 50%, leading to the reduction of more than 50% in the portion where the strip lines are nonexistent.

Therefore, the wide-width strip lines 210 constituting the superconducting layer 200 are uniformly arranged on the circumference, and make the vertical element of the magnetic field reduced, so that the deterioration in the efficiency of the superconducting cable or the AC loss may be reduced. Further, the adherence of the strip lines 210 to the circumference of the former 100 leads to the reduction in the external diameter of the whole cable.

Similarly, the strip lines 410 constituting the superconducting shield layer 400 are wound around and very closely attached to the circumference of the insulation layer 300, thereby reducing the gap between the neighboring strip lines 410. Therefore, the shielding current closer to the current flowing through the superconducting layer 210 may be induced to improve the shielding rate. The external diameter of the cable may also be reduced.

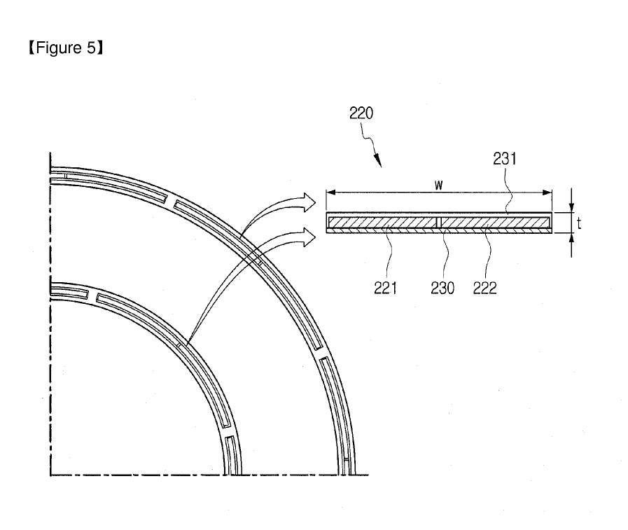

FIG. 5 is a diagrammatic view illustrating the cross-section and the arrangement of the superconducting strip line according to another embodiment.

FIG. 5 depicts a wide-width superconducting strip line 220 comprised of two pieces. That is, the strip line 220 is formed with two superconducting strip lines 221 and 222 having a narrow width arranged in parallel.

Specifically, the wide-width superconducting strip lines 220 according to the embodiment are formed with the narrow-width superconducting strip lines 221 and 222 having a thickness of about 0.4 mm integrally arranged in the direction of the width in parallel. The whole width of the wide-width strip lines 220 integrally formed with the two narrow-width strip lines 221 and 222 is about 20 to 30 times wider than their thickness. That is, the aspect ratio is about 20 to 30. This description about the strip lines constituting the superconducting layer 200 is similarly applied to the wide-width superconducting strip lines constituting the superconducting shield layer.

For example, two narrow-width strip lines 221 and 222 having the thickness (t) of 0.4 mm may be arranged side by side in order for the whole width to be 8 mm or more. In this case, the superconducting strip lines having the thickness of 0.4 mm and the width of 4 mm, as they are, may be used.

Meanwhile, a substrate 230 may be, as seen in typical superconducting strip lines, a fundamental layer formed as a supporting layer or the combination of the supporting layer and a buffer layer. The supporting layer may be made up of metallic tapes such as nickel (Ni), and the buffer layer may be made of materials such as MgO, YSZ, or CeO₂ and is coated on the surface of the supporting layer.

Returning to FIG. 5, a protecting layer 231 may be further formed on the upper surface of the two narrow-width strip lines 221 and 222. The protecting layer 231 is made up of a material such as silver (Ag). Therefore, the two strip lines 221 and 222 may be integrally attached to the lower substrate 230 by the protecting layer 231, or may be attached on the substrate 230 by soldering. The supporting layer, the buffer layer, and the protecting layer may be easily found in such a publication as Korean Patent No. 742501.

The superconducting cable having the wide-width superconducting strip lines may improve the capability related to the magnetic field (such as the magnitude of the critical current, or the capacity of transmitting power), and thus reduce the AC loss.

### INDUSTRIAL APPLICABILITY

According to the embodiment herein, because the superconducting layer is formed with wide-width superconducting strip lines having the aspect ratio of 20 to 30, the strip lines may adhere closely to the former and be wound around the circumference of the former.

Further, the gap between neighboring strip lines may be reduced.

Moreover, the cable according to the embodiment may prevent to deteriorate the efficiency of the cable, by reducing the vertical element of the magnetic field occurred around the strip lines. And the structure disclosed herein may reduce the whole intensity of the magnetic field, and reduce the whole outer diameter of the cable, which realizes a high quality superconducting cable so that the cable may be advantageously used in the fields relating to the power transmission.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1. A superconducting cable having wide-width superconducting strip lines, comprising, from the center of the cable, a former, a superconducting layer, an electronic insulation layer, and a superconducting shield layer,
wherein the superconducting layer is formed as a plurality of superconducting strip lines spirally wound around the circumference of the former, wherein each of the superconducting strip lines has a rectangular cross section, and
wherein the superconducting strip lines are, respectively, made up of a wide-width strip line of which the ratio of the width to the thickness is within the range of 20 to 30.

2. The superconducting cable according to claim 1, wherein each of the superconducting strip lines is a piece of strip line having a thickness of 0.5 mm or less.

3. The superconducting cable according to claim 1, wherein each of the superconducting strip lines is formed as two strip lines integrally arranged on a substrate side by side in the direction of the width, wherein each of the two strip lines has a thickness of 0.5 mm or less,
and
wherein the whole width of the two strip lines integrally arranged is 20 to 30 times larger than the thickness of the two strip lines.

4. A superconducting cable having wide-width superconducting strip lines, comprising, from the center of the cable, a former, a superconducting layer, an electronic insulation layer, and a superconducting shield layer,
wherein the superconducting layer is formed as a plurality of superconducting strip lines spirally wound around the circumference of the former, wherein each of the superconducting strip lines has a rectangular cross section,
wherein the shield layer is formed as a plurality of superconducting strip lines spirally wound around the circumference of the insulation layer, wherein each of the superconducting strip lines has a rectangular cross section, and
wherein the superconducting strip lines are, respectively, made up of a wide-width strip line of which the ratio of the width to the thickness is within the range of 20 to 30.

5. The superconducting cable according to claim 4, wherein each of the superconducting strip lines is a piece of strip line having a thickness of 0.5 mm or less.

6. The superconducting cable according to claim 4, wherein each of the superconducting strip lines is formed as two strip lines integrally arranged on a substrate side by side in the direction of the width, wherein each of the two strip lines has a thickness of 0.5 mm or less,
and
wherein the whole width of the two strip lines integrally arranged is 20 to 30 times larger than the thickness of the two strip lines.
